(19) United States
(12) Patent Application Publication
(10) Pub. No.: US 2026/0245105 A1
(43) Pub. Date: Aug. 20, 2026

(54) LARGE SCALE DATA MODELING USING MACHINE LEARNING

(71) Applicant: Tarun Batchu, Powell, OH (US)

(72) Inventor: Tarun Batchu, Powell, OH (US)

(21) Appl. No.: 19/057,302

(22) Filed: Feb. 19, 2025

(51) Int. Cl. G06Q 30/0201; G06N 7/01

(52) U.S. Cl. CPC G06Q 30/0201; G06N 7/01

(57) ABSTRACT

Examples described herein provide a computer-implemented method for large-scale data modeling using machine learning. The method includes receiving migration data from multiple countries. The method further includes integrating the migration data into a multi-modular machine learning model by: performing agent-based modeling of the migration data, performing network analysis on the migration data, and performing labor market analysis on the migration data. The method further includes performing web scraping on online resources to extract real-time or near-real-time migration-related information. The method further includes performing multi-group confirmatory factor analysis on the multi-modular machine learning model to identify underlying constructs behind how different countries shape foreign policy and migration quotas. The method further includes generating real-time suggestions for policymakers to optimize migration policies based on the multi-modular machine learning model and the real-time or near-real-time migration-related information.

### STATEMENT REGARDING PRIOR DISCLOSURES BY THE INVENTOR OR A JOINT INVENTOR

The following disclosures are submitted under 35 U.S.C. 102 (b) (1) (A):
“NEXUS: Advanced Macrodynamic Modeling and Optimization of International Migration Utilizing Web-Scraping Derived NLPs, Agent-Based Models+Network Analysis, and Labor-Market Analysis Inclusive of Behavioral Economics Ultimately Parameterized by Multi-Group CFA Data” by Tarun Batchu on Jun. 6, 2024; and
“NEXUS: Advanced Macrodynamic Modeling of Global Migration Through Web Scraping NLP's, Network analysis, and Game Theory” by Tarun Batchu on Sep. 18, 2024.

### BACKGROUND

Embodiments described herein generally relate to processing systems, and more specifically, to large-scale data modeling using machine learning.

Large-scale data modeling involves modeling very large volumes of data, such as data relating to world populations and migratory information. For example, in the context of migration data, large-scale data modeling involves designing models to analyze and interpret complex patterns in the movement of populations. This type of data often encompasses vast and dynamic datasets, including demographic information, geographic trajectories, socioeconomic factors, and temporal trends. The modeling process ingests diverse data sources, handles missing or inconsistent data, and employs advanced computational techniques, such as spatial-temporal modeling, machine learning, and big data analytics, to analyze the data. Visualization tools and geographic information systems (GIS) are also useful in presenting insights on migration flows, hotspots, and trends. This approach aids in understanding drivers of migration, predicting future movements, and informing policy decisions on resource allocation, urban planning, and humanitarian efforts.

### SUMMARY

According to an embodiment, a computer-implemented method for large-scale data modeling using machine learning is provided. The method includes receiving migration data from multiple countries. The method further includes integrating the migration data into a multi-modular machine learning model by: performing agent-based modeling of the migration data, performing network analysis on the migration data, and performing labor market analysis on the migration data. The method further includes performing web scraping on online resources to extract real-time or near-real-time migration-related information. The method further includes performing multi-group confirmatory factor analysis on the multi-modular machine learning model to identify underlying constructs behind how different countries shape foreign policy and migration quotas. The method further includes generating real-time suggestions for policymakers to optimize migration policies based on the multi-modular machine learning model and the real-time or near-real-time migration-related information.

In addition to one or more of the features described herein, or as an alternative, further embodiments of the method may include that the migration data includes economic data, social data, and political factors.

In addition to one or more of the features described herein, or as an alternative, further embodiments of the method may include that performing the agent-based modeling uses an European Union database and an Organization for Economic Co-operation and Development database.

In addition to one or more of the features described herein, or as an alternative, further embodiments of the method may include that performing the network analysis uses range-based centrality indices using World Bank data.

In addition to one or more of the features described herein, or as an alternative, further embodiments of the method may include running Monte Carlo simulations to validate and test the accuracy of the multi-modular machine learning model.

In addition to one or more of the features described herein, or as an alternative, further embodiments of the method may include that the multi-modular machine learning model incorporates game theory and econometric analysis to address economic drivers and optimize migration returns.

In addition to one or more of the features described herein, or as an alternative, further embodiments of the method may include adjusting predictions of the multi-modular machine learning model based on the real-time or near-real-time migration-related information.

In addition to one or more of the features described herein, or as an alternative, further embodiments of the method may include that performing the network analysis includes evaluating the influence of countries within the migration network using a Short-Range Interaction Centrality Index (SRIC) and a Long-Range Interaction Centrality Index (LRIC).

In addition to one or more of the features described herein, or as an alternative, further embodiments of the method may include that the model generates as output an optimized migration policy for a country that maximize benefits for both migrants and governments while maintaining equity and utility.

According to another embodiment, embodiment a computer system is provided that includes a processor set, one or more computer-readable storage media, and program instructions stored on the one or more computer-readable storage media to cause the processor set to perform operations for large-scale data modeling using machine learning. The operations include receiving migration data from multiple countries. The operations further include integrating the migration data into a multi-modular machine learning model by: performing agent-based modeling of the migration data, performing network analysis on the migration data, and performing labor market analysis on the migration data. The operations further include performing web scraping on online resources to extract real-time or near-real-time migration-related information. The operations further include performing multi-group confirmatory factor analysis on the multi-modular machine learning model to identify underlying constructs behind how different countries shape foreign policy and migration quotas. The operations further include generating real-time suggestions for policymakers to optimize migration policies based on the multi-modular machine learning model and the real-time or near-real-time migration-related information.

In addition to one or more of the features described herein, or as an alternative, further embodiments of the system may include that the migration data includes economic data, social data, and political factors.

In addition to one or more of the features described herein, or as an alternative, further embodiments of the system may include that performing the agent-based modeling uses an European Union database and an Organization for Economic Co-operation and Development database.

In addition to one or more of the features described herein, or as an alternative, further embodiments of the system may include that performing the network analysis uses range-based centrality indices using World Bank data.

In addition to one or more of the features described herein, or as an alternative, further embodiments of the system may include that the operations further include running Monte Carlo simulations to validate and test the accuracy of the multi-modular machine learning model.

In addition to one or more of the features described herein, or as an alternative, further embodiments of the system may include that the multi-modular machine learning model incorporates game theory and econometric analysis to address economic drivers and optimize migration returns.

In addition to one or more of the features described herein, or as an alternative, further embodiments of the system may include that the operations further include adjusting predictions of the multi-modular machine learning model based on the real-time or near-real-time migration-related information.

In addition to one or more of the features described herein, or as an alternative, further embodiments of the system may include that performing the network analysis includes evaluating the influence of countries within the migration network using a Short-Range Interaction Centrality Index (SRIC) and a Long-Range Interaction Centrality Index (LRIC).

In addition to one or more of the features described herein, or as an alternative, further embodiments of the system may include that the model generates as output an optimized migration policy for a country that maximize benefits for both migrants and governments while maintaining equity and utility.

According to yet another embodiment, a computer program product is provided. The computer program product includes one or more computer-readable storage media and program instructions stored on the one or more computer-readable storage media to perform operations for large-scale data modeling using machine learning. The operations include receiving migration data from multiple countries. The operations further include integrating the migration data into a multi-modular machine learning model by: performing agent-based modeling of the migration data, performing network analysis on the migration data, and performing labor market analysis on the migration data. The operations further include performing web scraping on online resources to extract real-time or near-real-time migration-related information. The operations further include performing multi-group confirmatory factor analysis on the multi-modular machine learning model to identify underlying constructs behind how different countries shape foreign policy and migration quotas. The operations further include generating real-time suggestions for policymakers to optimize migration policies based on the multi-modular machine learning model and the real-time or near-real-time migration-related information.

In addition to one or more of the features described herein, or as an alternative, further embodiments of the computer program product may include that the migration data comprises economic data, social data, and political factors.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 depicts a flow diagram of a method for optimizing international migration policies using a comprehensive and integrated approach according to one or more embodiments described herein;

FIG. 2 depicts a flow diagram of a method for optimizing international migration policies using a comprehensive and integrated approach according to one or more embodiments described herein;

FIGS. 3A, 3B, 3C, and 3D together depict a method 300 for optimizing international migration policies using a comprehensive and integrated approach according to one or more embodiments described herein;

FIGS. 4A and 4B depict an environmental monitoring device according to one or more embodiments described herein; and

FIG. 5 depicts a block diagram of a processing system for implementing one or more embodiments described herein.

The diagrams depicted herein are illustrative. There can be many variations to the diagram or the operations described therein without departing from the scope of the embodiments described herein. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

One or more embodiments described herein provide for large-scale data modeling using machine learning. An example of large-scale data modeling is modeling global migrations of populations. More particularly, one or more embodiments described herein provide a comprehensive and integrated approach to modeling global migration using advanced machine learning techniques, network analysis, agent-based modeling, and web scraping with natural language processing (NLP).

Current international migration policies face significant challenges due to a lack of global cooperation and inadequate modeling techniques that fail to consider a globalized approach. Fragmented and inconsistent policies across different countries, coupled with slow and overburdened bureaucratic systems, exacerbate the inefficiencies in managing migration. Security concerns, humanitarian issues, and economic factors further complicate the landscape, as countries struggle to balance secure borders with their humanitarian obligations and labor market needs. Negative public opinion and rising xenophobia influence political rhetoric, often leading to restrictive policies that hinder effective integration. Additionally, the failure to adhere to international laws and human rights standards, along with the reactive nature of current policies, highlights the need for a cohesive, proactive, and well-funded global strategy. Addressing root causes, such as conflict, poverty, and climate change, and developing robust, coordinated international responses, are useful for creating sustainable solutions to the complex issue of migration. Moreover, current international migration polices are largely reactive and do not account for real-time or near-real-time changes to migration of populations due to changes in environmental, political, legal, or other circumstances.

Existing solutions to migration modeling, such as gravity models, are limited by their simplistic assumptions and inability to capture the multifaceted nature of migration decision-making or real-time or near-real-time data. Gravity models typically assume that migration flows between two countries are proportional to the size of the countries and inversely proportional to the distance between them. This approach overlooks non-economic factors, such as social sentiment, political stability, and cultural ties, which significantly influence migration patterns. Furthermore, current models often fail to account for the dynamic and evolving nature of migration processes, leading to inaccurate predictions and ineffective policy recommendations. Policymakers, who are not typically trained in advanced mathematical techniques, find these models challenging to interpret and apply, resulting in suboptimal policy decisions that do not adequately address the complexities of international migration.

One or more embodiments described herein, addresses these challenges by integrating advanced macrodynamic modeling techniques with a multi-modular machine learning framework. One or more embodiments utilizes agent-based models, network analysis, and labor-market analysis, incorporating behavioral economics to provide a comprehensive and accurate representation of global migration patterns. By employing web-scraping and NLP, one or more embodiments provides for gathering real-time or near-real-time data from various sources, including websites, news outlets, and social media networks, to update the model so that the model remains current and responsive to emerging trends. Multi-group confirmatory factor analysis (MGCFA) identifies underlying constructs behind how different countries shape their foreign policy and migration quotas, allowing for a nuanced understanding of international migration dynamics. One or more embodiments runs Monte Carlo simulations to validate and test the accuracy of the model, generating real-time suggestions for policymakers to optimize migration policies. By incorporating game theory and econometric analysis, one or more embodiments addresses economic drivers and optimizes migration returns, providing a robust tool for policymakers to develop effective and equitable migration strategies.

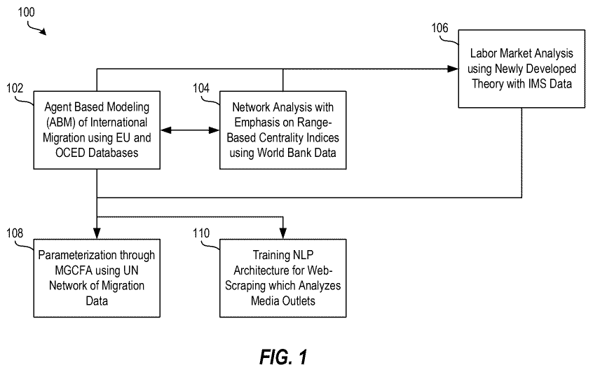

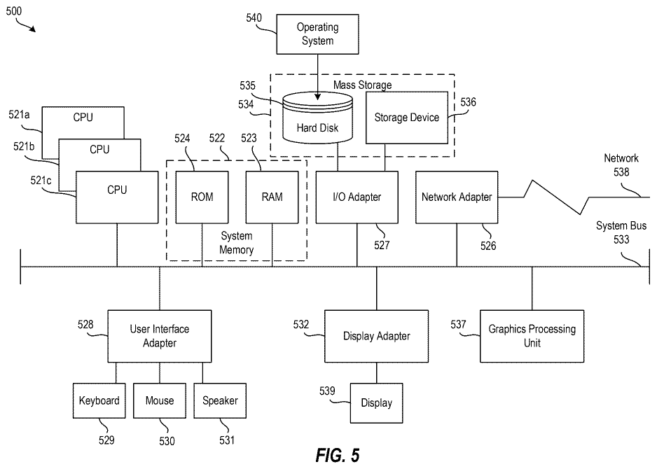

FIG. 1 depicts a flow diagram of a method 100 for optimizing international migration policies using a comprehensive and integrated approach according to one or more embodiments described herein. The method 100 can be implemented by any suitable system or device, such as the processing system 500 of FIG. 5.

Operation 102 involves agent-based modeling (ABM) of international migration using databases from the European Union (EU) and the Organization for Economic Co-operation and Development (OECD). This operation models the interactions and behaviors of individual agents, representing migrants, to simulate and analyze migration patterns. Agent-based modeling are computer based simulations used to study the interactions between people, things, places, and time. ABM are stochastic models used as mathematical models of systems and phenomena in a random manner. ABM are stochastic models built from the bottom up, meaning individual agents are assigned certain attributes. ABM of human migration with respect to their decision-making rules are used according to one or more embodiments. As an example, ABM can be used to generate a schematic representation of framing low-wage labor migration as a complex dynamic system across multiple geographic spaces: agents, networks, and exogenous influencers. ABM can also include a schema exemplifying an environment mediated form of interaction in which the spatial structure of the environment has a central role in determining the agents' perceptions and their possibility to interact. ABM can include evaluating different decision theories according to various criteria, as shown in the following table:

| | | | | | | | | |
|---|---|---|---|---|---|---|---|---|
| | Difference | | | | | | | |
| | desired − | | | | Time | | | |
| Decision | actual | Social | | Life | for | Empirical | | |
| Theory | behavior | Influence | Uncertainty | Course | decision | Relevance | Simple | Falsifiable |

| | | | | | | | |
|---|---|---|---|---|---|---|---|
| Minimalist | | App. | S.A. | | | App. | App. |
| Micro- | | S.A. | App. | | | App. | S.A. |
| Economic | | | | | | | |
| Psycho- | App. | App. | App. | App. | S.A. | | App. |
| Social | | | | | | | |
| Heuristic | | App. | App. | App. | | App. | App. |
| Mixture | App. | App. | App. | | App. | | S.A. |
| Empiracle | | App. | App. | App. | App. | | |

In this table, “App.” indicates the decision theory is applicable to the criteria and “S.A.” indicates the decision theory is somewhat applicable to the criteria. Blank boxes indicate the decision theory is not applicable to the criteria.

The evaluation assesses decision theories for their effectiveness in modeling migration within agent-based models, considering various criteria, such as those shown in the table. These criteria cover various aspects, such as accommodating gaps between intentions and actions, incorporating social influences, handling uncertainty, situating migration decisions within life courses and demographic events, accounting for planning duration, grounding in empirical evidence and decision theory, balancing simplicity and complexity, and ensuring falsifiability. By examining how these theories are applied in agent-based models and potentially extending their applicability, the evaluation aims to identify theories that best capture the complexities of migration decision-making.

Operation 104 focuses on network analysis with an emphasis on range-based centrality indices using World Bank data. This operation examines the interconnected nature of migration flows between countries, identifying nodes and pathways within the global migration network. Network analysis models international migration as a weighted-directed graph where nodes represent countries and edges denote migration stocks or flows between them. This approach allows for examining the interconnected nature of migration flows globally, rather than viewing countries as isolated entities. According to one or more embodiments, data from sources like the United Nations Population Division: 2015 Revision (45 country migratory flows) and 2022 Revision (63 country migrators flows) were used to construct the network. Modeled after network theory developed by (Faud et al., 2016) but with newer data. Short-range interaction centrality index (SRIC) and Long-range interaction centrality index (LRIC) can be emphasized, which account for the indirect interactions between countries and population of the destination country.

SRIC considers node attributes, such as country population, and indirect influences between nodes, particularly in the context of migration flows, according to the following equation:

$$f ( b , {w}_{a} ) = \frac{{p}_{ba} + {p}_{ba}^{′}}{\vert {w}_{a} \vert}$$

The intensity of connections f(i, wₐ) are estimated using this equation, where wₐ is a critical group of countries with respect to a country A (country of origin) in which a country B (destination country) is considered pivotal, p_{ba} is a total number of migrants coming from country A directly to country B, and p_{ba} is a total number of migrants coming from country A to country B indirectly, via any other country.

SRIC evaluates direct influence by setting a critical migrant inflow threshold at 0.1% of the destination country's population. A “critical” group of countries is determined when certain countries combined migrant population exceeds a quota relative to the destination country's population. Pivotal countries within this group are those whose removal would render the group non-critical.

LRIC uses a matrix based approach for examining long-range interactions. A matrix A of bilateral migration flows is constructed A=aᵢⱼ where aᵢⱼ is the migration flow from country i to country j. A matrix C is then constructed as C=cᵢⱼ where cᵢⱼ is defined with respect to the matrix A and a predefined quota according to the following equation:

$${c}_{ij} = \{ \begin{matrix}\frac{{a}_{ij}}{{min}_{Ω ( i ) ⊆ {N}_{i} \vert j ∈ {Ω}_{p} ( i )} {\sum }_{l ∈ Ω ( i )} {a}_{il}} , & if j ∈ {Ω}_{p} ( i ) ⊆ {N}_{i} , \\ 0 , & if j ∉ {Ω}_{p} ( i ) ⊆ {N}_{i} ,\end{matrix}$$

where Ω(i) is a critical group of direct neighbors for the element i, Ω(i)⊆Nᵢ, and Ωₚ(i) is a critical group for the element i, Ωₚ(i)⊆Ω(i). A group of neighbors of the node iΩ(i)⊆Nᵢ is critical if Σ_{l∈Ω(i)}aᵢₗ>qᵢ.

The matrix C can be interpreted simply: if c=1, the country of migrant origin (j) has the highest influence on the destination country (i); conversely, if c=0, the origin country has no direct influence on the destination. Values between 0 and 1 indicate varying levels of impact.

Using SRIC and LRIC, a schematic representation of inter-nodal network theory can be implemented, where direct and indirect influences between elements are expressed between elements i and j via the k-th patch Pₖ^{ij}, respectively, using the following two equation:

$$f ( {P}_{k}^{ij} ) = {c}_{ij ( 1 , k )} \cdot {c}_{j ( 1 , k ) j ( 2 , k )} \cdot … \cdot {c}_{j ( n ( k ) , k ) j} ,$$

$$f ( {P}_{k}^{ij} ) = min ( {c}_{ij ( 1 , k )} \cdot {c}_{j ( 1 , k ) j ( 2 , k )} \cdot ⋯ \cdot {c}_{j ( n ( k ) , k ) j} ) ,$$

where j(l, k), l=1, n (k) is an l-th element that occurs on k-th ρ-path from i to j. These equations define the indirect influence of f(Pₖ^{ij}) between elements i and j via the k-th path Pₖ^{ij}.

Operation 106 pertains to labor market analysis with data from the International Monetary System (IMS). This operation analyzes the economic drivers of migration, assessing labor market demands, migrant skills, and integration into the workforce. Economic prosperity is a useful indicator of push-pull factors of migration: it can be a significant reason why immigrants are turned down at borders and why governments make difficult decisions about immigration. Studying econometrics and labor-market analysis is useful for optimizing and maximizing migration returns because these tools provide a deep understanding of the economic impacts of migration. This helps policymakers forecast economic outcomes, such as job market fluctuations and gross domestic product (GDP) growth, resulting from migration. Labor-market analysis, assesses the supply and demand for labor, the skills of migrants, and their integration into the workforce. The Mayda framework and the Tarasyev framework can be applied economic theory, and data from IMS is used.

The inflow of migrants into a region should correspond to the labor resources demand of the labor market. To estimate and predict the migration flows between countries with different levels of socio-economic development, a dynamic multi-factor model was developed, which is based on the assumptions of the positional games theory and allows to predict the behavior of each individual, depending on economic factors. According to one or more embodiments, the model is developed using Russian economy post-collapse of the Soviet Union in the 1990's because migration was a large driver of the economy.

The model described herein incorporates the idea of interconnectedness and modeling with network analysis, particularly integrating network responsibility and burden of individual countries in a larger network. This provides a globalized approach that yields change. The model can be expressed by the following equations:

$$max \frac{δ U}{δ {θ}_{IA}} = {p}_{SI} \cdot v [ {U}_{DC} ( λ ) + {θ}_{BF} \cdot {ψ}_{MN} ] - v \cdot [ ( 1 - {p}_{SI} ) \cdot ( {U}_{DC} - {U}_{SC} ) ] - {δ}_{MSD} - {μ}_{MPI} = 0$$

$$g \to central network utility of intermigration$$

where δU/δθIA represents the rate of change in total utility (U) with respect to the government's acceptance, U represents overall utility function for the destination country from immigration decisions, OIA represents independent action taken by the destination country on the share of immigrants accepted, v represents volume or velocity of migration flows per unit time, UDC(λ) represents the utility derived by the host country from the immigrant's integration, including contributions to the labor market, skills, and other resources, λ denotes factors like skill level or productivity, θBF·ψMN represents a burden-sharing adjustment factor reflecting responsibilities and costs within migration networks, PSI is a probability or weight of successful integration for the migrant population, USC is the utility that the migrant had in the source country (SC) (reflecting pre-migration conditions), λMSD represents the marginal cost of managing systemic disruptions due to migration, such as social unrest or strain on infrastructure, and μMPI represents a marginal penalty imposed by migration policies or quotas (e.g., legal, administrative, or political constraints).

This developed model indicates that governments/countries should accept a portion of immigrants relative to their connection and burden within their migration networks. This model also highlights how different types of immigrants fulfill different quantifiable amounts of said burden.

Operation 108 involves parameterization through multi-group confirmatory factor analysis (MGCFA) using data from the UN network of migration. This operation identifies underlying constructs behind how different countries shape their foreign policy and migration quotas. Multi-group confirmatory factor analysis (MGCFA) is a statistical technique used to test whether a hypothesized factor structure is consistent across different groups. This approach extends confirmatory factor analysis (CFA), which aims to validate the relationship between observed variables and their underlying latent constructs (factors). It is used to identify underlying constructs behind how governments shape their foreign policy as two different countries inherently would not have the same immigration policy. This approach considers quantitative factor analysis of data from the UN network of migration. A schematic representation of a path diagram and a model plot of the CFA obtained from a measure of ideal network migration policy can be generated.

Operation 110 includes training a natural language processing (NLP) architecture for web scraping, which analyzes real-time or near-real-time data. This operation gathers real-time or near-real-time data from various sources, including websites, news/media outlets, social media networks, and/or the like, including combinations and/or multiples thereof, to update the model with current trends, sentiment, and events affecting migration.

In many instance the current climate of foreign affairs or conflict is a large determinant of migration and can disrupt established trends. Web-scraping can be used to extract data from websites, news outlets, and other media, which then can be sentimentally analyzed and be used as a real-time news monitoring or event awareness tool. Web scraping involves extracting information from such resources (e.g., web pages) using NLP. NLP can help parse and process textual content obtained from these resources. Tools can be used to extract specific elements (e.g., text, links, or tables) from web pages and/or for comprehensively crawling and scraping websites. Information/data relating to immigration and/or social events that might impact immigration can be extracted using these tools. For example, a web scraping tool can be used to identify relevant text from a website. The text is input into an NLP pipeline that extracts keywords and detects similar/duplicate content. Results from the NLP pipeline are then stored to a knowledge graph along with results from the web scraping tool. The knowledge graph includes storing webpages and keywords as a directed graph of nodes and edges.

The method 100 is used to generate a multi-model deep learning model for providing a comprehensive and integrated approach to modeling global migration. According to one or more embodiments, this approach can use a combination of Python-HTML derived web-scraping NLP system and a migration modeling agent-based model and network analysis machine learning model.

The interactions between the operations 102, 104, 106, 108, 110 form a comprehensive and integrated approach to optimizing international migration policies. The method 100 leverages advanced modeling techniques, network analysis, labor market analysis, and real-time data collection through web-scraping to provide policymakers with accurate and actionable insights for developing effective migration strategies.

Additional processes also may be included, and it should be understood that the process depicted in FIG. 1 represents an illustration, and that other processes may be added or existing processes may be removed, modified, or rearranged without departing from the scope of the present disclosure.

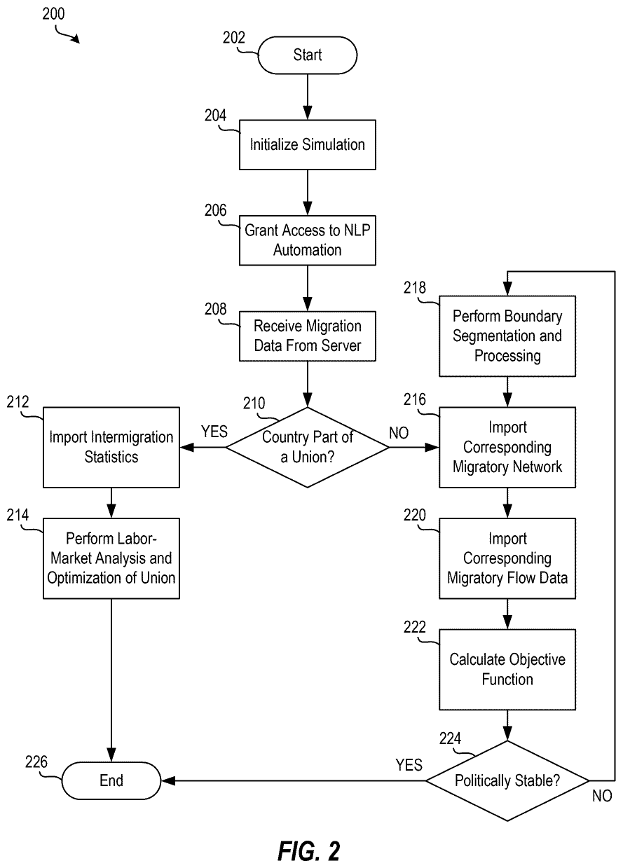

FIG. 2 depicts a flow diagram of a method 200 for optimizing international migration policies using a comprehensive and integrated approach according to one or more embodiments described herein. The method 200 can be implemented by any suitable system or device, such as the processing system 500 of FIG. 5.

The method 200 begins at Operation 202 with initializing the overall process for optimizing international migration policies. Operation 204 sets up the simulation environment, preparing the computational resources and parameters for the subsequent operations. Operation 206 includes enabling access to NLP automation, which will be used for analyzing textual data from various sources. Operation 208 includes receiving migration data from a server(s), which includes information on economic, social, and political factors affecting migration. Operation 210 includes checking whether the country in question is part of a union, such as the European Union (EU).

If the country is part of a union (Operation 210 “Yes”), Operation 212 imports the inter-migration statistics relevant to the union (e.g., the EU), providing data on migration flows between member countries. Operation 214 performs labor-market analysis and optimizes migration policies to align with the labor market needs of the union. Operation 226 then concludes for countries that are part of a union.

If the country is not part of a union (Operation 210 “No”), Operation 216 imports the migratory network data relevant to the non-union country, detailing migration flows to and from other countries. The migratory network data relates to connections between countries in which migration occurs. Operation 220 imports detailed migratory flow data, providing information on the movement of populations between countries defined in the migratory network. Operation 222 calculates an objective function, which is used to optimize migration policies based on the imported data. This involves evaluating various factors, such as economic impact, social integration, and political stability.

Operation 224 assesses the political stability of the country. If the country is considered politically stable (Operation 224 “Yes”), Operation 226 concludes the method 200. If the country is not politically stable (Operation 224 “No”), instability factors can be considered. For example, Operation 218 defines and processes the geographical boundaries relevant to the migration data and segments them into politically stable segments, ensuring accurate analysis.

The method 200 provides optimized migration policies that maximize benefits for both migrants and governments while maintaining equity and utility. The method 200 leverages advanced modeling techniques, network analysis, labor market analysis, and real-time data collection through web-scraping to provide policymakers with accurate and actionable insights for developing effective migration strategies.

According to one or more embodiments, the method 200 can be executed multiple times to perform simulations. For example, the simulations can be performed substantially 8,000 times at substantially 225 epochs, incorporating countries of various metrics of development and networks of many different sizes. For example, the model can use 42 inputs across many different aspects and generates 16 outputs while using swish and logistic activation functions. The average weight time for the model per country given a specific network is substantially 734 seconds, which can vary depending on country connections defined in the migratory network.

Additional processes also may be included, and it should be understood that the process depicted in FIG. 2 represents an illustration, and that other processes may be added or existing processes may be removed, modified, or rearranged without departing from the scope of the present disclosure.

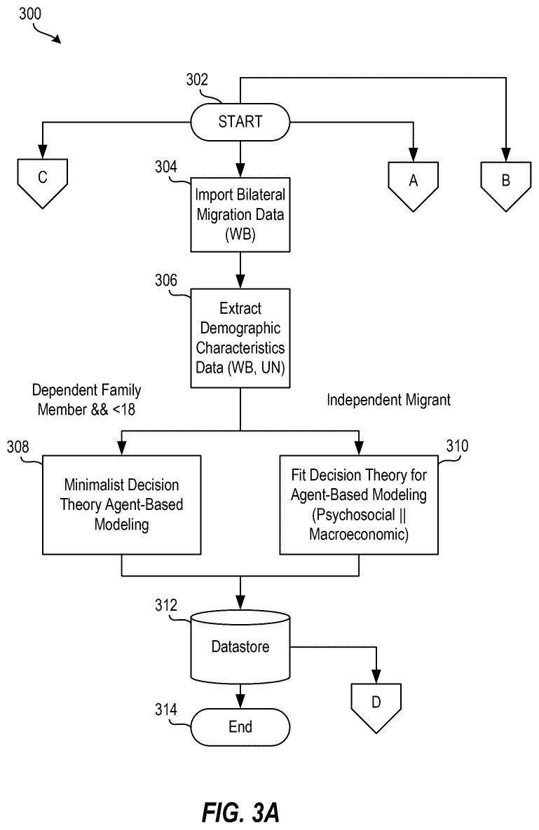

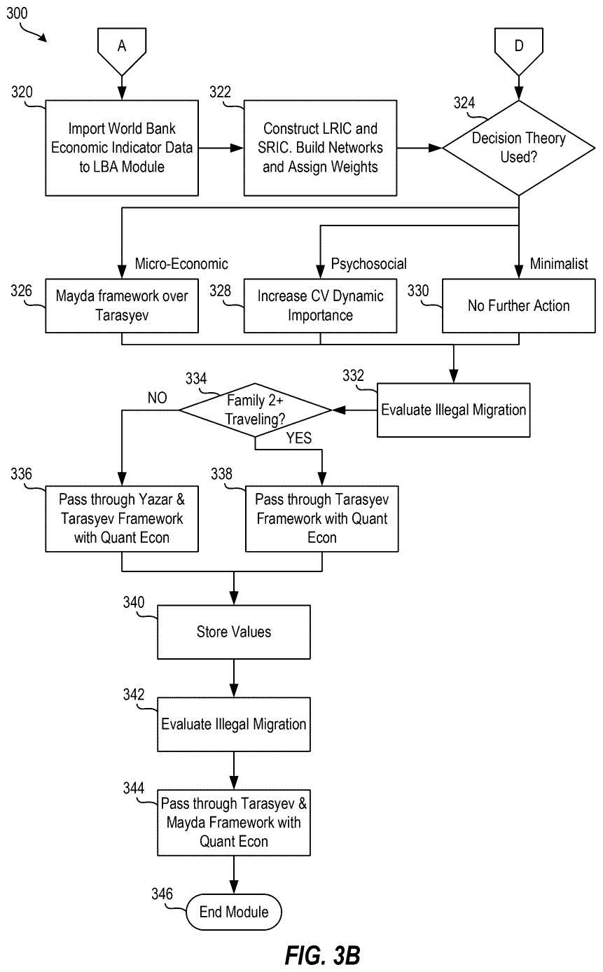

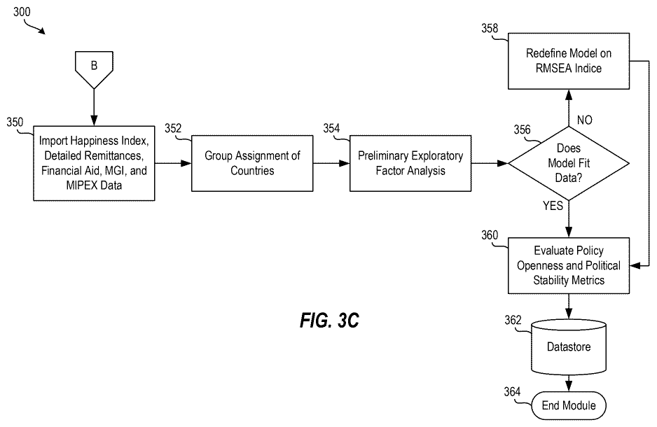

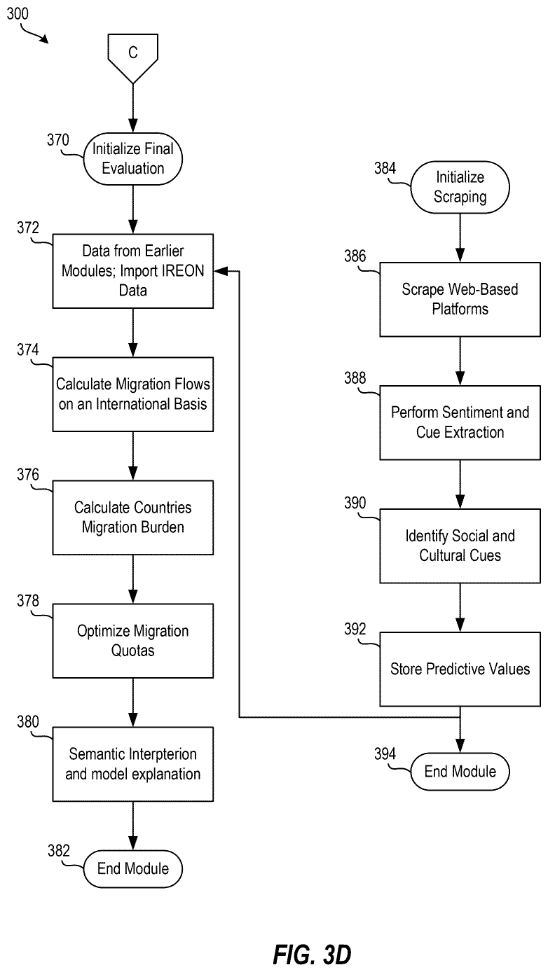

Together, FIGS. 3A, 3B, 3C, and 3D depict a method 300 for optimizing international migration policies using a comprehensive and integrated approach according to one or more embodiments described herein. The method 300 is described as being implemented by a system, which can be any suitable system or device, such as the processing system 500 of FIG. 5.

FIG. 3A depicts the initial steps of the method 300 for optimizing international migration policies. The method 300 starts at Operation 302. After the method 300 starts, the method proceeds along several flow paths to Operation 304 (FIG. 3A), Operation 320 (FIG. 3B), Operation 350 (FIG. 3C), and Operation 370 (FIG. 3D).

With reference to FIG. 3A, at Operation 304, the system begins by importing bilateral migration data from the World Bank. Following this, at Operation 306, the system extracts demographic characteristics data from the World Bank, the United Nations, and/or the like, including combinations and/or multiples thereof. The data is then categorized into two groups: dependent family members under the age of 18 (Operation 308) and independent migrants (Operation 310). For dependent family members, at Operation 308, the system applies a minimalist decision theory agent-based modeling approach as described herein. For independent migrants, at Operation 312, the system fits decision theories for agent-based modeling, which can be either psychosocial or macroeconomic. At Operation 312, the results from both approaches (e.g., Operation 308 and Operation 310) are stored in a datastore, and the method 300 concludes at Operation 314.

With reference to FIG. 3B continues the method 300 by detailing the operations implemented by a labor-market module. At operation 320, the system imports World Bank economic indicator data into a labor-based analysis (LBA) module (Operation 320). At operation 322, the system then constructs LRIC and SRIC indices as described herein, builds networks, and assigns weights. At operation 324, the system determines which decision theory is used: micro-economic, psychosocial, or minimalist. For micro-economic decision theories, at Operation 326, the system may apply the Mayda framework over the Tarasyev framework. For psychosocial decision theories, at Operation 328, the system increases the dynamic importance of the coefficient of variation. If a minimalist decision theory is used, at Operation 330, the system takes no further action. At operation 332, the system then evaluates whether the migration involves illegal migration. At operation 334, it is then determined whether a family of two or more is traveling. If a family of two or more is traveling (Operation 334 “Yes”), at Operation 338, the system passes the data through the Tarasyev framework with Quant Econ. If not (Operation 334 “No”), at Operation 336, the system passes the data through the Yazar and Tarasyev framework with Quant Econ. At operation 340, the system stores the values, and at operation 342, the system evaluates illegal migration. At Operation 334, the system passes the data through the Tarasyev and Mayda framework with Quant Econ and concludes the labor-market module at Operation 346.

With reference to FIG. 3C, illustrates the steps involved in performing factor analysis, which includes grouping countries and evaluating policy openness and political stability. At Operation 350, the system imports data, such as the happiness index (which is a comprehensive measure of well-being and happiness of a population), detailed remittances, financial aid, migration governance index (MGI), and migrant integration policy index (MIPEX) data. At Operation 352, the system then assigns countries into groups and, at Operation 354, performs a preliminary exploratory factor analysis. At Operation 356, the system checks whether the model fits the data. If the model does not fit the data (Operation 356 “No”), the system redefines the model based on the Root Mean Square Error of Approximation (RMSEA) index and proceeds to Operation 360. If the model fits the data (Operation 356 “Yes”) or subsequent to performing Operation 358, the system proceeds to Operation 360, where the system evaluates policy openness and political stability metrics. At operation 362, the results are stored in a datastore, and the module concludes at Operation 364.

With reference to FIG. 3D, an evaluation module and a web scraping process are described. At Operation 370, the system initializes the final model evaluation, and at Operation 372, data from earlier modules (e.g., FIGS. 3A-3C) and from web scraping (described herein), along with International Relations and Area Studies Online Data (IREON) data, is imported. At Operation 374, the system calculates migration flows on an international basis, and at Operation 376 calculates the migration burden for each country. At Operation 378, the system then optimizes migration quotas and, at Operation 380, provides semantic interpretation and model explanation. At Operation 382, the evaluation module concludes

Web scraping is now provided. At operation 384, the system initializes web scraping. At Operation 386, the system scrapes web-based platforms and, at Operation 388, performs sentiment and cue extraction. At operation 390, the system identifies social and cultural cues. At Operation 392, the system stores the predictive values and/or makes the predictive values available to other modules/operations, such as the evaluation module at Operation 372. The web scraping module concludes at Operation 394. Web scraping enables real-time or near-real-time data to be captured from global populations, which is useful for determining real-time or near-real-time events, sentiment, migration events, and/or the like, including combinations and/or multiples thereof.

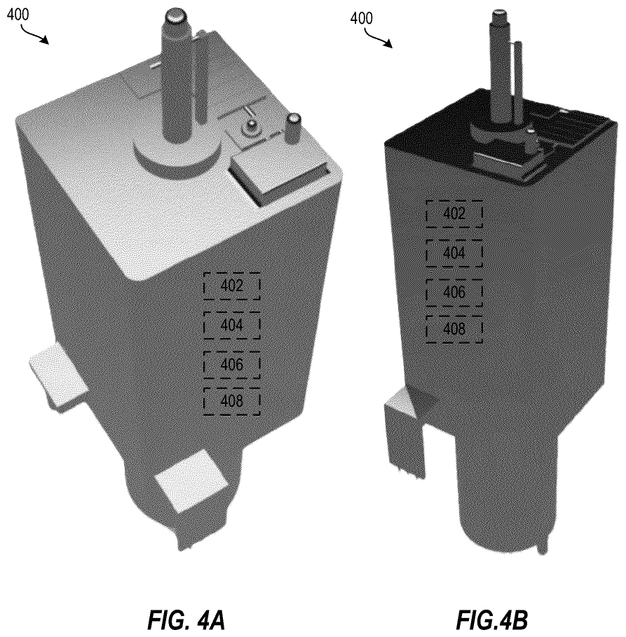

Turning now to FIGS. 4A and 4B, an environmental monitoring device 400 is described in the context of the one or more embodiments described herein. The environmental monitoring device is designed to reduce uncertainty in migration modeling by integrating various environmental factors that can influence migration patterns. This device aims to provide real-time or near-real-time data on environmental conditions, which can be useful for understanding and predicting migration flows. The components and functionalities of the environmental monitoring device are as follows

The device is equipped with a range of sensors 402 to monitor different environmental parameters. These sensors 402 includes one or more of the following: a temperature and humidity sensor that provides accurate measurements of ambient temperature and relative humidity; a gas sensor that detects the presence of various gases, which can be indicative of air quality and pollution levels; a multi-parameter water quality sensor that measures parameters such as pH, dissolved oxygen, turbidity, and conductivity, providing insights into water quality and availability; a soil moisture sensor that measures the moisture content in the soil, which is important for understanding agricultural conditions and potential droughts; and/or the like, including combinations and/or multiples thereof.

The device 400 includes communication modules 404 to transmit the collected data to a central server or cloud-based platform for analysis. The communication modules 404 can include: an IoT (Internet of Things) module that enables the device 400 to connect to the internet and transmit data in real-time; a Zigbee module, a low-power, wireless communication protocol suitable for short-range data transmission; a Bluetooth module that allows for wireless data transfer over short distances, useful for local data collection and monitoring; and/or the like, including combinations and/or multiples thereof.

The device 400 can also include custom Geographic Information System (GIS) software or encryption software 406. For example, the device 400 can be integrated with custom GIS software to map and analyze the collected environmental data spatially. This software helps visualize the data in relation to geographic locations, providing a clearer understanding of environmental conditions across different regions. Encryption software ensures the security and privacy of the transmitted data, protecting it from unauthorized access and tampering.

The device 400 can include a data collection and integration module 408 that provides for continuously collecting data on various environmental parameters. This data is then transmitted to a central server or cloud-based platform, where it is integrated with other migration-related data, such as economic, social, and political factors. The integrated data is used to update the model described herein, providing real-time insights into how environmental conditions are influencing migration patterns. This helps policymakers make informed decisions based on the latest environmental data.

The environmental monitoring device 400 can be deployed in various locations to monitor environmental conditions that may impact migration. For example, it can be used in regions prone to natural disasters, such as floods, droughts, or hurricanes, to provide early warnings and assess the potential impact on migration.

The device 400 can also be used in agricultural areas to monitor soil moisture and water quality, helping to predict potential food shortages and their impact on migration.

Overall, the environmental monitoring device 400 enhances the ability to model and predict migration patterns by providing real-time or near-real-time data on environmental factors. This comprehensive approach helps reduce uncertainty in migration modeling and enables policymakers to develop more effective and responsive migration policies.

The one or more embodiments described herein offer several technical advantages that enhance the effectiveness and accuracy of international migration policy optimization:

Comprehensive Integration of Multiple Modeling Techniques: By combining agent-based modeling, network analysis, labor market analysis, and behavioral economics, one or more embodiments provide a holistic approach to understanding and predicting migration patterns. This integration allows for a more nuanced and accurate representation of migration dynamics, considering both individual decision-making processes and macro-level network interactions.

Real-Time Data Collection and Analysis: The use of web-scraping and NLP to gather real-time data from various sources, such as websites, news outlets, and social media, ensures that the model remains current and responsive to emerging trends. This real-time data collection allows policymakers to adjust migration policies based on the latest information, improving the relevance and effectiveness of the policies.

Advanced Network Analysis with Centrality Indices: The introduction of Short-Range Interaction Centrality Index and Long-Range Interaction Centrality Index provides a more comprehensive understanding of migration networks. These indices account for both direct and indirect influences between countries, helping to identify influential nodes and pathways within the global migration network. This detailed network analysis informs policy decisions based on interconnectedness and the relative importance of different countries within the migration network.

Behavioral Economics and Game Theory Integration: Incorporating behavioral economics and game theory into the migration model allows for a deeper understanding of the economic drivers of migration. This integration helps to optimize migration returns by considering the strategic interactions between source and destination countries, as well as the impact of labor market conditions on migration decisions. This approach provides policymakers with insights into the economic factors influencing migration and helps to develop policies that balance labor market needs with migration.

Multi-Group Confirmatory Factor Analysis: The use of MGCFA to identify underlying constructs behind how different countries shape their foreign policy and migration quotas offers a unique advantage. This statistical technique helps to reveal the latent factors influencing policy decisions across different groups of countries, providing a nuanced understanding of international migration dynamics. This information enables policymakers to tailor migration policies to the specific needs and characteristics of different countries.

Monte Carlo Simulations for Validation: The use of Monte Carlo simulations to validate and test the accuracy of the model ensures robustness and reliability of the model. These simulations allow for extensive “what-if” testing of prospective government policies, providing a thorough validation of the model's predictions. This approach helps to identify potential weaknesses and improve the overall accuracy of the model.

Optimized Migration Policies: The embodiments generate real-time or near-real-time suggestions for policymakers to optimize migration policies based on the integrated data and analysis. By leveraging advanced modeling techniques, network analysis, labor market analysis, and real-time data collection, the model provides accurate and actionable insights for developing effective migration strategies. This results in optimized migration policies that maximize benefits for both migrants and governments while maintaining equity and utility.

Overall, the technical advantages of the one or more embodiments described herein lie in their ability to provide a comprehensive, accurate, and dynamic approach to modeling and optimizing international migration policies. These advantages enable policymakers to make informed decisions based on a thorough understanding of migration dynamics and real-time data, leading to more effective and equitable migration policies.

One or more embodiments described herein provide various improvements to the functioning of a computer, particularly in the context of optimizing international migration policies using advanced modeling techniques and real-time data analysis. These improvements enhance the computer's ability to process, analyze, and interpret complex data sets, leading to more accurate and actionable insights. Examples of improvements to computer functionality include:

### Enhanced Data Integration and Processing:

The NEXUS project integrates multiple data sources, including economic, social, political, and environmental data, into a single comprehensive model. This integration allows the computer to process and analyze diverse data sets simultaneously, improving the overall efficiency and accuracy of the analysis.

The use of advanced data processing techniques, such as Agent-Based Modeling (ABM), Network Analysis, and Labor Market Analysis, enables the computer to handle complex interactions and relationships within the data, providing a more nuanced understanding of migration patterns.

Real-Time Data Collection and Analysis: The incorporation of web-scraping and NLP techniques allows the computer to gather real-time or near-real-time data from various online sources, such as websites, news outlets, and social media. This real-time or near-real-time data collection ensures that the model remains current and responsive to emerging trends and events. The computer's ability to analyze real-time data and adjust predictions based on the latest information improves the relevance and effectiveness of the migration policies generated by the model. Given the enormous volume of migration-related data available worldwide across platforms and countries, it is simply unreasonable and unrealistic for a human, in its mind, to collect, comprehend, and analyze such data.

Optimized Resource Allocation: The environmental monitoring device integrated into the model to provide real-time or near-real-time data on environmental conditions, which can influence migration patterns. This data helps the computer update the model with the latest environmental information, improving the accuracy of migration predictions. The computer's ability to process and analyze environmental data from many different locations worldwide in conjunction with other migration-related data enables policymakers to make informed decisions based on a comprehensive understanding of the factors influencing migration. Again, given the enormous volume of migration-related data available worldwide across platforms, countries and environmental monitoring devices, it is simply unreasonable and unrealistic for a human, in its mind, to collect, comprehend, and analyze such data.

Scalability and Flexibility: One or more embodiments described herein leverages cloud computing and distributed processing capabilities to handle large-scale data sets and complex computations. This scalability allows the computer to process vast amounts of data efficiently where humans cannot, making the system suitable for global migration analysis. The flexible architecture of the model allows for the integration of additional data sources and modeling techniques as needed, ensuring that the system can adapt to new challenges and requirements in migration policy optimization.

Overall, one or more embodiments described herein introduces significant improvements to the functioning of a computer by enhancing its data integration, real-time analysis, advanced modeling capabilities, validation processes, resource allocation, scalability, and flexibility. These improvements enable the computer to provide more accurate, reliable, and actionable insights for optimizing international migration policies.

It is understood that one or more embodiments described herein is capable of being implemented in conjunction with any other type of computing environment now known or later developed. For example, FIG. 5 depicts a block diagram of a processing system 500 for implementing the techniques described herein. In accordance with one or more embodiments described herein, the processing system 500 is an example of a cloud computing node used in a cloud computing environment. In examples, processing system 500 has one or more central processing units (“processors” or “processing resources” or “processing devices”) 521a, 521b, 521c, etc. (collectively or generically referred to as processor(s) 521 and/or as processing device(s)). In aspects of the present disclosure, each processor 521 can include a reduced instruction set computer (RISC) microprocessor. Processors 521 are coupled to system memory (e.g., random access memory (RAM) 524) and various other components via a system bus 533. Read only memory (ROM) 522 is coupled to system bus 533 and may include a basic input/output system (BIOS), which controls certain basic functions of processing system 500.

Further depicted are an input/output (I/O) adapter 527 and a network adapter 526 coupled to system bus 533. I/O adapter 527 may be a small computer system interface (SCSI) adapter that communicates with a hard disk 523 and/or a storage device 525 or any other similar component. I/O adapter 527, hard disk 523, and storage device 525 are collectively referred to herein as mass storage 534. Operating system 540 for execution on processing system 500 may be stored in mass storage 534. The network adapter 526 interconnects system bus 533 with an outside network 536 enabling processing system 500 to communicate with other such systems.

A display 535 (e.g., a display monitor) is connected to system bus 533 by display adapter 532, which may include a graphics adapter to improve the performance of graphics intensive applications and a video controller. In one aspect of the present disclosure, adapters 526, 527, and/or 532 may be connected to one or more I/O busses that are connected to system bus 533 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 533 via user interface adapter 528 and display adapter 532. A keyboard 529, mouse 530, and speaker 531 may be interconnected to system bus 533 via user interface adapter 528, which may include, for example, a Super I/O chip integrating multiple device adapters into a single integrated circuit.

In some aspects of the present disclosure, processing system 500 includes a graphics processing unit 537. Graphics processing unit 537 is a specialized electronic circuit designed to manipulate and alter memory to accelerate the creation of images in a frame buffer intended for output to a display. In general, graphics processing unit 537 is very efficient at manipulating computer graphics and image processing, and has a highly parallel structure that makes it more effective than general-purpose CPUs for algorithms where processing of large blocks of data is done in parallel.

Thus, as configured herein, processing system 500 includes processing capability in the form of processors 521, storage capability including system memory (e.g., RAM 524), and mass storage 534, input means such as keyboard 529 and mouse 530, and output capability including speaker 531 and display 535. In some aspects of the present disclosure, a portion of system memory (e.g., RAM 524) and mass storage 534 collectively store the operating system 540 to coordinate the functions of the various components shown in processing system 500.

Various embodiments are described herein with reference to the related drawings. Alternative embodiments can be devised without departing from the scope of the claims. Various connections and positional relationships (e.g., over, below, adjacent, etc.) are set forth between elements in the following description and in the drawings. These connections and/or positional relationships, unless specified otherwise, can be direct or indirect, and the embodiments described herein are not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of #8% or 5%, or 2% of a given value.

The flowchart and block diagrams in the figures illustrate the architecture, functionality, and operation of possible implementations of systems, methods, and computer program products according to various embodiments described herein. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for large-scale data modeling using machine learning, the method comprising:
receiving migration data from multiple countries;
integrating the migration data into a multi-modular machine learning model by:
performing agent-based modeling of the migration data;
performing network analysis on the migration data; and
performing labor market analysis on the migration data;
performing web scraping on online resources to extract real-time or near-real-time migration-related information;
performing multi-group confirmatory factor analysis on the multi-modular machine learning model to identify underlying constructs behind how different countries shape foreign policy and migration quotas; and
generating real-time suggestions for policymakers to optimize migration policies based on the multi-modular machine learning model and the real-time or near-real-time migration-related information.

2. The computer-implemented method of claim 1, wherein the migration data comprises economic data, social data, and political factors.

3. The computer-implemented method of claim 1, wherein performing the agent-based modeling uses an European Union database and an Organization for Economic Co-operation and Development database.

4. The computer-implemented method of claim 1, wherein performing the network analysis uses range-based centrality indices using World Bank data.

5. The computer-implemented method of claim 1, further comprising running Monte Carlo simulations to validate and test the accuracy of the multi-modular machine learning model.

6. The computer-implemented method of claim 1, wherein the multi-modular machine learning model incorporates game theory and econometric analysis to address economic drivers and optimize migration returns.

7. The computer-implemented method of claim 1, further comprising adjusting predictions of the multi-modular machine learning model based on the real-time or near-real-time migration-related information.

8. The computer-implemented method of claim 1, wherein performing the network analysis comprises evaluating the influence of countries within the migration network using a Short-Range Interaction Centrality Index (SRIC) and a Long-Range Interaction Centrality Index (LRIC).

9. The computer-implemented method of claim 1, wherein the model generates as output an optimized migration policy for a country that maximize benefits for both migrants and governments while maintaining equity and utility.

10. A computer system comprising:
a processor set;
one or more computer-readable storage media; and
program instructions stored on the one or more computer-readable storage media to cause the processor set to perform operations for large-scale data modeling using machine learning, the operations comprising:
receiving migration data from multiple countries;
integrating the migration data into a multi-modular machine learning model by:
performing agent-based modeling of the migration data;
performing network analysis on the migration data; and
performing labor market analysis on the migration data;
performing web scraping on online resources to extract real-time or near-real-time migration-related information;
performing multi-group confirmatory factor analysis on the multi-modular machine learning model to identify underlying constructs behind how different countries shape foreign policy and migration quotas; and
generating real-time suggestions for policymakers to optimize migration policies based on the multi-modular machine learning model and the real-time or near-real-time migration-related information.

11. The computer system of claim 10, wherein the migration data comprises economic data, social data, and political factors.

12. The computer system of claim 10, wherein performing the agent-based modeling uses an European Union database and an Organization for Economic Co-operation and Development database.

13. The computer system of claim 10, wherein performing the network analysis uses range-based centrality indices using World Bank data.

14. The computer system of claim 10, wherein the operations further comprise running Monte Carlo simulations to validate and test the accuracy of the multi-modular machine learning model.

15. The computer system of claim 10, wherein the multi-modular machine learning model incorporates game theory and econometric analysis to address economic drivers and optimize migration returns.

16. The computer system of claim 10, wherein the operations further comprise adjusting predictions of the multi-modular machine learning model based on the real-time or near-real-time migration-related information.

17. The computer system of claim 10, wherein performing the network analysis comprises evaluating the influence of countries within the migration network using a Short-Range Interaction Centrality Index (SRIC) and a Long-Range Interaction Centrality Index (LRIC).

18. The computer system of claim 10, wherein the model generates as output an optimized migration policy for a country that maximize benefits for both migrants and governments while maintaining equity and utility.

19. A computer program product comprising:
one or more computer-readable storage media; and
program instructions stored on the one or more computer-readable storage media to perform operations for large-scale data modeling using machine learning, the operations comprising:
receiving migration data from multiple countries;
integrating the migration data into a multi-modular machine learning model by:
performing agent-based modeling of the migration data;
performing network analysis on the migration data; and
performing labor market analysis on the migration data;
performing web scraping on online resources to extract real-time or near-real-time migration-related information;
performing multi-group confirmatory factor analysis on the multi-modular machine learning model to identify underlying constructs behind how different countries shape foreign policy and migration quotas; and
generating real-time suggestions for policymakers to optimize migration policies based on the multi-modular machine learning model and the real-time or near-real-time migration-related information.

20. The computer program product of claim 19, wherein the migration data comprises economic data, social data, and political factors.
